(19) United States
(12) Patent Application Publication
(10) Pub. No.: US 2014/0313505 A1
(43) Pub. Date: Oct. 23, 2014

(54) OPTICAL FIBER HOLE INSERTION DETECTION DEVICE

(71) Applicant: HON HAI PRECISION INDUSTRY CO., LTD., New Taipei (TW)

(72) Inventor: CHANG-WEI KUO, New Taipei (TW)

(73) Assignee: HON HAI PRECISION INDUSTRY CO., LTD., New Taipei (TW)

(21) Appl. No.: 14/254,907

(22) Filed: Apr. 17, 2014

(30) Foreign Application Priority Data
Apr. 23, 2013 (TW) 102114465

(51) Int. Cl. G01B 11/08; G01B 11/02

(52) U.S. Cl. CPC G01B 11/08; G01B 11/02
USPC 356/73.1

(57) ABSTRACT

An optical fiber hole insertion detection device for detecting diameters and lengths of optical fiber hole insertions includes a fixing member, an image capturing unit, a processor, and a display unit. The fixing member fixes the optical fiber hole insertions. The image capturing unit is positioned above the fixing member and is configured to capture a first image and a second image. The first image shows the optical fiber hole insertions along a radial direction, and the second image shows the optical fiber hole insertions along a lengthwise direction. The processor is electrically connected to the image capturing unit and is configured to calculate the diameters and lengths of the optical fiber hole insertions and to analyze whether each optical fiber hole insertion is a qualified product or not according to the diameters and lengths and a predetermined range. The display unit shows the analysis result of the processor.

### BACKGROUND

1. Technical Field

The present disclosure relates to measurement technologies and, particularly, to an optical fiber hole insertion detection device.

2. Description of Related Art

An optical fiber coupling connector includes a receiving member defining a number of optical fiber holes, an optical coupling lens, a number of optical fibers, a number of light emitting modules, and a number of light receiving modules. The optical fibers are received in the optical fiber holes. The receiving member plugs in the optical coupling lens, such that the optical fiber optically couples with the light emitting modules and the light emitting modules through the optical coupling lens. The transmission efficiency of light depends on an optical coupling precision between the optical fibers and the light emitting modules and between the optical fibers and the light receiving modules. In particular, the higher the optical coupling precision is, the higher the transmission efficiency. The diameter and length of each of the optical fiber holes, which determine the optical coupling precision, are two important factors of the quality of the optical fiber holes. In order to determine the quality of the optical fiber hole, diameters and lengths of optical fiber hole insertions for molding the optical fiber holes need to be precisely detected. However, it is difficult to detect the diameters and lengths of optical fiber hole insertions because each of the insertions is long and thin. This will result in errors.

Therefore, it is desirable to provide an optical fiber hole insertion detection device, to overcome or at least alleviate the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric, schematic view of an optical fiber hole insertion detection device including a fixing member, an image capturing unit, and a processor, according to an exemplary embodiment.

FIG. 2 is an isometric, schematic view showing the fixing member of FIG. 1 fixing a number of optical fiber hole insertions.

FIG. 3 is a schematic view of a first image captured by the image capturing unit of FIG. 1.

FIG. 4 is a functional block diagram of the process of FIG. 1.

### DETAILED DESCRIPTION

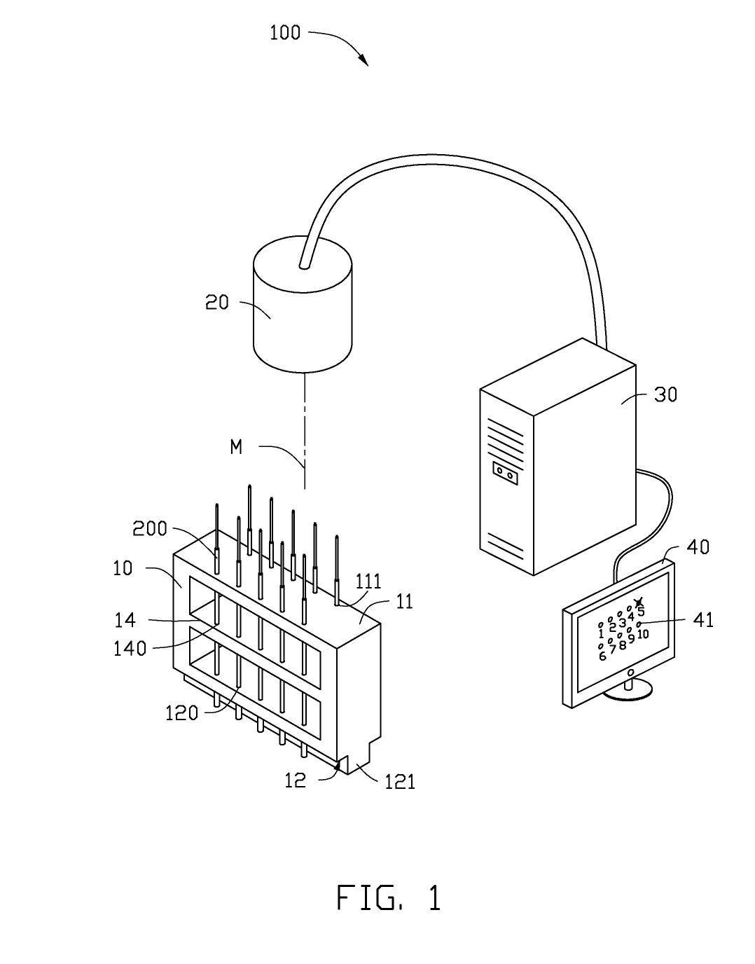

FIG. 1 shows an optical fiber hole insertion detection device 100 in accordance with an exemplary embodiment. The optical fiber hole insertion detection device 100 is configured to detect diameters and lengths of ten optical fiber hole insertions 200 and to analyze whether each of the ten optical fiber hole insertions 200 is a qualified product or not according to the diameters and the lengths.

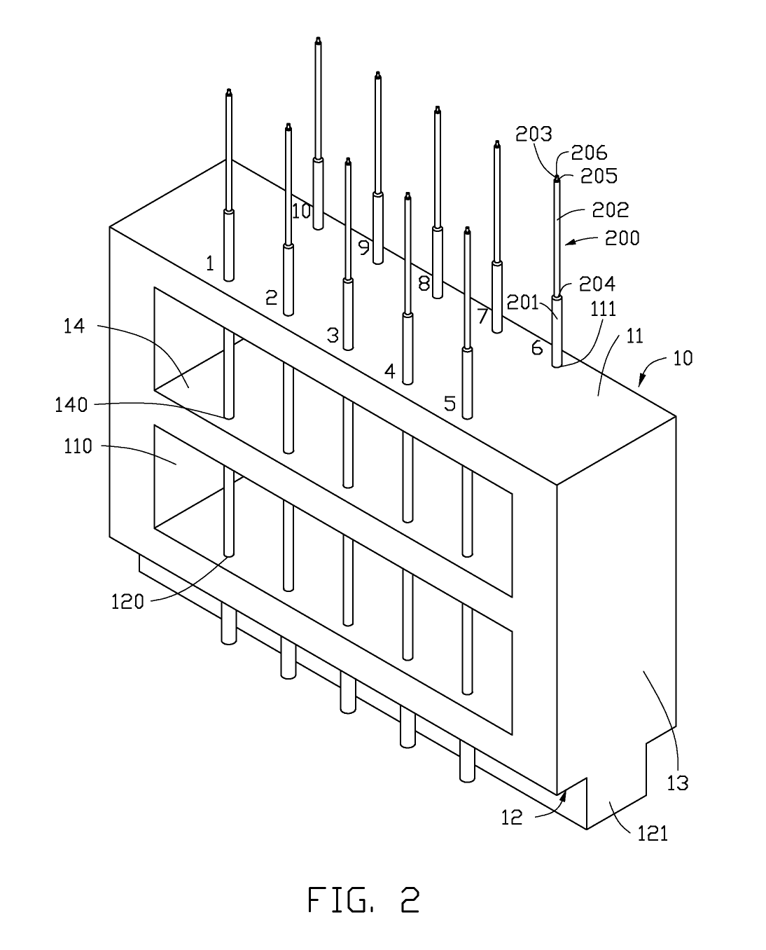

FIG. 2 shows that each of the optical fiber hole insertion 200 includes a main portion 201 which is substantially circular in cross-section, a concentric middle portion 202, and a concentric front portion 203. The main portion 201 consists of a core portion, a first cladding portion surrounding the core portion, and a second cladding portion surrounding the first cladding portion. The middle portion 202 consists of the core portion and the first cladding portion exposed from the main portion 201, and the middle portion 202 has a certain critical length. The front portion 203 consists of the core portion exposed from the middle portion 202, and the front portion 203 has a certain critical length. The main portion 201 includes a first end surface 204. An outer diameter of the first end surface 204 is equal to that of the main portion 201. The middle portion 202 includes a second end surface 205. An outer diameter of the second end surface 205 is equal to that of the middle portion 202. The front portion 203 includes a third end surface 206. An outer diameter of the third end surface 206 is equal to that of the front portion 203. The outer diameter of the first end surface 204 is larger than that of the second end surface 205, and the outer diameter of the second end surface 205 is larger than that of the third end surface 206.

The optical fiber hole insertion detection device 100 includes a fixing member 10, an image capturing unit 20, a processor 30, and a display unit 40.

The fixing member 10 is configured to fixing the optical fiber hole insertions 200. The fixing member 10 is substantially hollow and includes an upper wall 11, a lower wall 12, and two side walls 14. The upper wall 11 and the lower wall 12 are positioned at opposite sides of the fixing member 10, and the upper wall 11 is substantially parallel to the lower wall 12. The two side walls 14 are positioned at opposite sides of the fixing member 10 and are substantially parallel to each other. The two side walls 14 are interconnected between the upper wall 11 and the lower wall 12. The upper wall 11, the lower wall 12, and the two side walls 14 cooperatively form a receiving cavity 110.

The upper wall 11 defines ten first through holes 111 labeled from 1 to 10. The ten first through holes 111 are arranged in a 2*5 array and communicate with the receiving cavity 110. The lower wall 12 defines ten second through holes 120. The ten second through holes 120 are arranged in a 2*5 array and communicate with the receiving cavity 110. The ten second through holes 120 align with the respective ten first through holes 111. A partition plate 14 is arranged in the receiving cavity 110. Opposite ends of the partition plate 14 are fixed to the two side walls 13, such that the partition plate 14 divides the receiving cavity 110 into two portions. The partition plate 14 defines ten third through holes 140. The ten third through holes 140 are arranged in a 2*5 array and align with the ten first through holes 111 and the ten second through holes 120. A supporting block 121 protrudes from the lower wall 12 outside the receiving cavity 110. The supporting block 121 is sandwiched between two rows of the first through holes 111, between two rows of the second through holes 120, and two rows of the third through holes 140. The ten optical fiber hole insertions 200 are fixed by the fixing member 10 in a manner that ten main portions 201 of the optical fiber hole insertions 200 extend through the respective first through holes 111, the respective second through holes 120, and the respective third through holes 140.

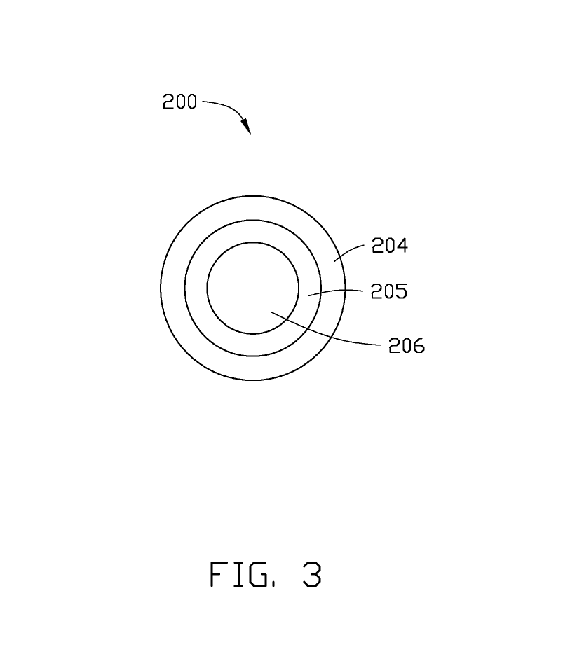

The image capturing unit 20 is typically a digital camera and is positioned above the fixing member 10 to capture a first image and a second image. The first image shows the optical fiber hole insertions 200 along a radial direction of the optical fiber hole insertions 200. The second image shows the optical fiber hole insertions 200 along a lengthwise direction of the optical fiber hole insertions 200. When an optical axis M of the image capturing unit 20 coincides with the lengthwise direction of the optical fiber hole insertions 200, the image capturing unit 20 captures the first image. The first image includes the first end surface 204, the second end surface 205, and the third end surface 206 of each of the optical fiber hole insertions 200 (shown in FIG. 3). When an optical axis M of the image capturing unit 20 coincides with the radial direction of the optical fiber hole insertions 200, the image capturing unit 20 captures the second image. The second image includes the entire optical fiber hole insertions 200 along the lengthwise direction.

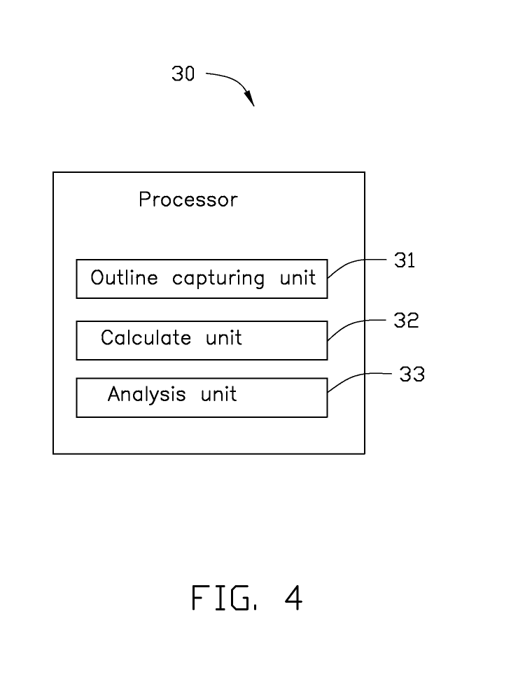

The processor 30 is electrically connected to the image capturing unit 20. FIG. 4 shows that the processor 30 includes an outline capturing unit 31, a calculate unit 32, and an analysis unit 33. The outline capturing unit 31 is configured to capture an outline of the first end surface 204, an outline of the second end surface 205, and an outline of the third end surface 206 of each of the optical fiber hole insertions 200 of the first image and an outline of each of the optical fiber hole insertions 200 of the second image. The calculate unit 32 is configured to calculate the diameter of each of the first end surfaces 204, the diameter of each of the second end surfaces 205, and the diameter of each of the third end surface 206s, calculate the length of each of the optical fiber hole insertions 200, calculate a first average diameter of the ten first end surfaces 204, calculate a second average diameter of the ten second end surfaces 205, calculate a third average diameter of the ten third end surfaces 206, and calculate an average length of the ten optical fiber hole insertions 200.

The analysis unit 33 is configured to analyze whether a first difference value between the diameter of each of the first end surfaces 204 and the first average diameter satisfy a predetermined range, whether a second difference value between the diameter of each of the second end surfaces 205 and the second average diameter satisfy the predetermined range, whether a third difference value between the diameter of each of the third end surfaces 203 and the third average diameter satisfy the predetermined range, and whether a fourth difference value between the length of each of the ten optical fiber hole insertions 200 and the average length satisfy the predetermined range. In this embodiment, the predetermined range is about from 0.3 millimeters to 0.5 millimeters.

When all of the first difference value, the second difference value, the third difference value, and the fourth difference value of each of the optical fiber hole insertions 200 satisfy the predetermined range, it represents that the optical fiber hole insertion 200 is a qualified product. When one of the first difference value, the second difference value, the third difference value, and the fourth difference value of each of the optical fiber hole insertions 200 does not satisfy the predetermined range, it represents that the optical fiber hole insertion 200 is not a qualified product.

The display unit 40 is electrically connected to the processor 30 and is configured to display the analysis result of the processor 30. In detail, ten marks 41 labeled from 1 to 10 are shown in the display unit 40. The ten marks 41 correspond to the qualities of the ten optical fiber hole insertions 200, and the ten labels of the ten marks 41 correspond to the ten labels of the ten first through holes 111. For example, if the optical fiber hole insertion 200 in the first through hole 111 labeled 5 is not a qualified product, and the optical fiber hole insertions 200 in the first through holes 111 labeled 1-4 and 6-10 are qualified products, the mark 41 labeled 5 will show an “X”, and the marks 41 labeled 1-4 and 6-10 will show circles.

An optical fiber hole insertion detection method using the optical fiber hole insertion detection device 100 includes the following steps.

First, ten optical fiber hole insertions 200 are fixed by the fixing member 10. In detail, ten main portions 201 of the optical fiber hole insertions 200 extend through the respective first through holes 111, the respective second through holes 120, and the respective third through holes 140.

Second, a first image showing the optical fiber hole insertions 200 along a radial direction of the optical fiber hole insertions 200 is captured. The first image includes the ten first end surfaces 204, the ten second end surface ten 205, and the ten third end surfaces 206 of the ten optical fiber hole insertions 200.

Third, diameters of the ten first end surfaces 204, a first average diameter of the ten first end surfaces 204, and ten first difference values between the diameters of the ten first end surfaces 204 and the first average diameter are calculated.

Fourth, whether the first difference values satisfy a predetermined range is analyzed. If the first difference value of the optical fiber hole insertion 200 satisfies the predetermined range, the detection steps of the optical fiber hole insertion 200 (hereinafter “the first round detected insertion 200”) will go on. If the first difference value of the optical fiber hole insertion 200 does not satisfy the predetermined range, the display unit 40 will show an “X” to represent that the optical fiber hole insertion 200 is not a qualified product.

Fifth, diameters of the second end surfaces 205 of the first round detected insertions 200, a second average diameter of the second end surfaces 205 of the first round detected insertions 200, and second difference values between the diameters of the second end surfaces 205 and the second average diameter are calculated.

Sixth, whether the second difference values satisfy the predetermined range is analyzed. If the second difference value of the first round detected insertion 200 satisfies the predetermined range, the detection steps of the first round detected insertion 200 (hereinafter “the second round detected insertion 200”) will go on. If the second difference value of the first round detected insertion 200 does not satisfy the predetermined range, the display unit 40 will show an “X” to represent that the first round detected insertion 200 is not a qualified product.

Seventh, diameters of the third end surfaces 206 of the second round detected insertions 200, a second average diameter of the third end surfaces 206 of the second round detected insertions 200, and second difference values between the diameters of the third end surfaces 206 and the third average diameter are calculated.

Eighth, whether the third difference values satisfy the predetermined range is analyzed. If the second difference value of the second round detected insertion 200 satisfies the predetermined range, the detection steps of the second round detected insertion 200 (hereinafter “the third round detected insertion 200”) will go on. If the third difference value of the second round detected insertion 200 does not satisfy the predetermined range, the display unit 40 will show an “X” to represent that the second round detected insertion 200 is not a qualified product.

Ninth, a second image showing the optical fiber hole insertions 200 along a lengthwise direction of the optical fiber hole insertions 200 is captured.

Tenth, lengths of the third round detected insertions 200, an average length of the third round detected insertions 200, and fourth difference values between the lengths of the third round detected insertions 200 and the average length are calculated.

Eleventh, whether the fourth difference values satisfy the predetermined range is analyzed. If the fourth difference value of the third round detected insertion 200 satisfies the predetermined range, the display unit 40 will show a circle to represent that the third round detected insertion 200 is a qualified product. If the fourth difference value of the third round detected insertion 200 does not satisfy the predetermined range, the display unit 40 will show an “X” to represent that the third round detected insertion 200 is not a qualified product.

Even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An optical fiber hole insertion detection device for detecting diameters and lengths of optical fiber hole insertions, the optical fiber hole insertion detection device comprising:
a fixing member for fixing the optical fiber hole insertions;
an image capturing unit positioned above the fixing member and configured to capture a first image and a second image, the first image showing the optical fiber hole insertions along a radial direction thereof, and the second image showing the optical fiber hole insertions along a lengthwise direction thereof;
a processor electrically connected to the image capturing unit and configured to calculate the diameters and the lengths of the optical fiber hole insertions and to analyze whether each of the optical fiber hole insertions is a qualified product or not according to the diameters and the lengths and a predetermined range; and
a display unit showing the analysis result of the processor.

2. The optical fiber hole insertion detection device of claim 1, wherein the fixing member comprises an upper wall, a lower wall opposite to the upper wall, and two opposing side walls connecting the upper wall to the lower wall, all of the upper wall, the lower wall, and the two side walls cooperatively form a receiving cavity, the upper wall defines a plurality of first through holes, the lower wall defines a plurality of second through holes aligning with the first through holes, and the optical fiber hole insertions extend through the respective first through holes and the respective second through holes.

3. The optical fiber hole insertion detection device of claim 2, further comprising a partition plate arranged in the receiving cavity, wherein opposite sides of the partition plate are fixed to the two side walls, the partition plate defines a plurality of third through holes aligning with the second through holes and the first through holes, and the optical fiber hole insertions extend through the respective first through holes, the respective third through holes, and the respective second through holes.

4. The optical fiber hole insertion detection device of claim 2, comprising a supporting block protruding from the lower wall outside the receiving cavity, and the supporting block sandwiched between two rows of the first through holes and between two rows of the second through holes.

5. The optical fiber hole insertion detection device of claim 1, wherein the processor comprises an outline capturing unit, a calculate unit, and a analysis unit, the outline capturing unit is configured to capture an outline of each of the optical fiber hole insertions of the first image and the second image, the calculate unit is configured to calculate a diameter and a length of each of the optical fiber hole insertions, to calculate an average diameter and an average length of the optical fiber hole insertion, and to calculate difference values between the average diameter and the diameter of each of the optical fiber hole insertions and between the average length and the length of each of the optical fiber hole insertions according to the outlines, and the analysis unit is configured to analyze whether the difference values satisfy the predetermined range.

6. The optical fiber hole insertion detection device of claim 5, wherein the predetermined range is about from 0.3 millimeters to 0.5 millimeters.

7. The optical fiber hole insertion detection device of claim 5, wherein when all of the difference values of each of the optical fiber hole insertions satisfy the predetermined range, it represented that each of the optical fiber hole insertions is a qualified product, when one of the difference values of a specific one of the optical fiber hole insertions does not satisfy the predetermined range, it represented that the specific optical fiber hole insertion is not a qualified product.

8. The optical fiber hole insertion detection device of claim 5, wherein a plurality of marks labeled in sequence are shown in the display unit, the marks correspond to the qualities of the optical fiber hole insertions, and the labels of the marks correspond to the labels of the first through holes.

9. The optical fiber hole insertion detection device of claim 8, wherein if the optical fiber hole insertion in the first through hole is not a qualified product, the mark corresponding to the first through hole will show an “X”.

10. The optical fiber hole insertion detection device of claim 8, wherein if the optical fiber hole insertion in the first through hole is a qualified product, the mark corresponding to the first through hole will show a circle.
